(19) United States
(12) Patent Application Publication
(10) Pub. No.: US 2004/0109811 A1
(43) Pub. Date: Jun. 10, 2004

(54) Process for reductive bleaching of alkaline earth metal carbonates

(76) Inventors: Mark Daniel Mortimer, Christleton (GB); Christopher R.L. Golley, St. Austell (GB); Deborah Susan Thrale, St. Blazey (GB); Desmond C. Payton, St. Austell (GB); Florangel D. Perez, Earth City, MO (US); Mark Windebank, Cornwall (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/467,673

(22) PCT Filed: Feb. 13, 2002
(86) PCT No.: PCT/US02/04168

(30) Foreign Application Priority Data
Feb. 13, 2001 (GB) 0103500.5

(51) Int. Cl. C01F 5/24

(52) U.S. Cl. 423/430

(57) ABSTRACT

A process for improving the brightness of an alkaline earth metal carbonate utilizing formamidine sulfinic acid or sodium dithionite as a reductive bleaching agent is disclosed. Where the alkaline earth metal carbonate is calcium carbonate, addition of the reductive bleaching agent to an aqueous slurry of the calcium carbonate takes place prior to, during, or after formation of the carbonate, which is chosen from at least one of a precipitated calcium carbonate and a ground calcium carbonate.

### FIELD OF THE INVENTION

The present invention relates to reductively bleached alkaline earth metal carbonate products, their preparation, and their use. In particular, the invention is concerned with a process for preparing improved calcium carbonate products to be used in compositions for paper making and coating, paints, plastics, rubber, and the like.

### BACKGROUND OF THE INVENTION

Producers of paper, paper coatings, plastic compositions, rubber compositions, and non-aqueous surface coatings such as paints and film laminates, use mineral materials such as calcium carbonate as property enhancing pigments or fillers in these and like products. The importance of the appearance of these products is significant, especially in the finer grades of printing and writing papers, plastics employed in consumer goods, and decorative surface coatings. For such products, whiteness and brightness are key appearance factors and the majority of these products require a calcium carbonate having the highest degree of whiteness and brightness.

Calcium carbonate products are generally supplied in the form of precipitated calcium carbonate (PCC) or ground calcium carbonate (GCC). PCC is generally prepared by a process in which calcium carbonate is calcined to produce calcium oxide, or “quicklime,” the quicklime is then “slaked” with water to produce an aqueous suspension of calcium hydroxide, and finally, the calcium hydroxide is carbonated with a carbon-dioxide-containing gas to produce the precipitated calcium carbonate. GCC may comprise a ground naturally occurring calcium carbonate from sources such as marble, limestone, chalk and the like. PCC may also be ground.

Various methods for improving the brightness of PCCs and GCCs are known in the art. For example, U.S. Pat. No. 4,793,985 discloses the oxidative bleaching of calcium carbonate using ozone. U.S. Pat. No. 5,188,814 discloses the oxidative bleaching of calcium carbonate using hydrogen peroxide.

The use of reductive bleaching agents such as sodium dithionite (hydros), also known as sodium hydrosulfite, and formamidine sulfinic acid (FAS), also known as thiourea dioxide, to bleach clays and pulp fibers is known. However, FAS bleaching has not been reported for calcium carbonate due to a variety of factors. These factors include the effect on the bleaching process of the greater pH (i.e. >7) dictated by the solution chemistry of calcium carbonate, the high solids processing conditions of calcium carbonate which limit the recovery of the leached iron from the system, and issues of color reversion. U.S. Pat. Nos. 4,900,533, 4,239,736, and 4,824,653, disclose the use of hydros to bleach calcium carbonate products, but require either a chelating agent, a flocculating agent, or substantially pure carbon dioxide to achieve measurable brightness increases.

It would therefore be advantageous to provide a PCC or GCC product having improved whiteness and brightness via a process which could utilize raw calcium carbonate sources of inferior quality, i.e. containing larger amounts of iron and manganese containing impurities than those specified above, and also, for PCC, without the prohibitive cost associated with, for example, the use of substantially pure carbon dioxide.

### SUMMARY OF THE INVENTION

The present invention achieves these and other advantages and comprises a process, composition, and product produced by the process, which substantially obviates one or more of the limitations and disadvantages described above. The written description which follows describes additional features and advantages of the invention, which will also become apparent or learned by practice of the invention.

According to a first aspect of the present invention embodied and broadly described herein, there is provided a process for providing an improved alkaline earth metal carbonate product comprising the steps of:

(a) preparing an aqueous slurry of an alkaline earth metal carbonate material, and

(b) adding to the slurry an amount of formamidine sulfinic acid sufficient to achieve reductive bleaching of the alkaline earth metal carbonate material. In a second aspect of the present invention, there is provided a process for producing an improved alkaline earth metal carbonate product comprising the steps of:

(1) slaking an alkaline earth metal oxide in water to form an aqueous slurry of alkaline earth metal hydroxide,

(2) adding to the alkaline earth metal hydroxide slurry from about 0.01 % to about 1.0% of a reductive bleaching agent, based on the weight of dry alkaline earth metal carbonate product, and

(3) carbonating the alkaline earth metal hydroxide aqueous slurry at a temperature of at least about 50° C. with a carbon dioxide containing gas that is not substantially pure carbon dioxide to form a purified, reductively bleached alkaline earth metal carbonate aqueous slurry.

In a third aspect of the invention there is provided a composition of matter comprising an alkaline earth metal carbonate aqueous slurry combined with an amount of formamidine sulfinic acid sufficient to achieve reductive bleaching of the alkaline earth metal carbonate aqueous slurry.

Beneficially, we have found that by preparing an alkaline earth metal carbonate product by the method of the first and second aspects of the invention, alkaline earth metal carbonate compositions may be produced having an enhanced brightness.

### DETAILED DESCRIPTION

The present invention provides a novel process that utilizes reductive bleaching agents to improve the brightness of alkaline earth metal carbonate products, a product produced thereby, and a composition, for use in paper, polymer, rubber and plastic production, paints coatings, films and the like, incorporating such a product. The term “paper” embraces products which are of paper, board, card and the like.

In a first aspect, the novel process of the present invention provides an improved alkaline earth metal carbonate product by the steps of (a) preparing an aqueous slurry of an alkaline earth metal carbonate material and adding to the slurry an amount of formamidine sulfinic acid (FAS) sufficient to achieve reductive bleaching of the alkaline earth metal carbonate material. In the description of the present invention, the terms “suspension” and “slurry” are used interchangeably to refer to a dispersion of finely divided solid particles in a liquid medium.

The alkaline earth metal carbonate preferably is chosen from at least one of a calcium carbonate such as PCC or GCC, and a magnesium containing carbonate, such as dolomite. Most preferably, the alkaline earth metal carbonate is a calcium carbonate. In the description that follows, the description of parameters relating to calcium carbonate also apply to other suitable alkaline earth metal carbonates and vice versa.

The calcium carbonate may be a naturally occurring calcium carbonate such as the marble, limestone, or chalk derived products used by the paper industry for coating and filling compositions. And/or the calcium carbonate may be a PCC, such as scalenohedral, rhombohedral, aragonitic, or vateritic PCC's used by the paper industry for coating and filling compositions. The calcium carbonate may be a GCC (ground naturally occurring calcium carbonate material), a ground PCC, or mixtures thereof.

Where the product of the invention is a precipitated calcium carbonate, preferably step (a) may comprise further step(s) for synthesizing the precipitated calcium carbonate. The further step(s) may be well-known to a person skilled in the art and may comprise a step of slaking calcium oxide (quicklime) to produce slaked lime and carbonating the slaked lime with a carbon dioxide containing gas so as to produce the precipitated calcium carbonate. Such a process is disclosed in U.S. Pat. No. 5,833,747, which is incorporated herein by reference in its entirety.

It is preferred that the method of the invention comprise an intermediate grinding or milling step (especially where the calcium carbonate product is to be used in a paper coating composition) in which the aqueous suspension of calcium carbonate from step (a) is ground to a desired particle size prior to addition of the reductive bleaching agent according to step (b).

Formamidine sulfinic acid, the reductive bleaching agent used in the first aspect of the present invention, may also be referred to by the names thiourea dioxide or FAS. FAS may be added to the aqueous calcium carbonate suspension of step (a) in solid form, or in the form of a solution, or in suspension.

In accordance with the first aspect of the present invention, where the aqueous suspension of alkaline earth metal carbonate is a naturally occurring calcium carbonate, such as, e.g., marble, chalk and limestone, the reductive bleaching agent FAS may be added during step (a), or after step (a) and before and/or after the grinding step.

Where the aqueous suspension of alkaline earth metal carbonate is a PCC, the reductive bleaching agent FAS may be added during the PCC synthesis of step (a), which comprises (1) a calcium oxide slaking step and (2) a slaked lime carbonation step, or after step (a). The FAS is preferably added during the carbonation step. The FAS may also be added before or after the grinding step, or both before and after the grinding step.

It has been found that grinding of the calcium carbonate suspension may disadvantageously cause a decrease in the brightness of the calcium carbonate particles. By adding a reductive bleaching agent to the calcium carbonate suspension according to the method of the invention, it has beneficially been found that the brightness of the calcium carbonate particles can be recovered and further enhanced.

The calcium carbonate product produced by the method of the present invention may advantageously have a brightness which has been enhanced by in the range of from about 2 to about 10 units. Preferably, the calcium carbonate product may have an ISO brightness on the order of from about 85 to about 98 units. The brightness of the products produced by the process of the present invention can be measured by means of standard methods known to those of ordinary skill in the art. Two such standard methods are the TAPPI and the ISO standard test methods. 2000-2001 TAPPI test methods for brightness are available via ISBN No. 1-930657-500-1, which is incorporated herein by reference in its entirety. ISO test methods are available via the publication ISO 2470:1999 Paper, Board and Pulps—Measurement of diffuse blue reflectance factor (ISO brightness), which is incorporated herein by reference in its entirety, from http://www.iso.org. Some specific TAPPI and ISO standards for brightness measurement are:

T 452 om-98 Brightness of pulp, paper, and paperboard (directional reflectance at 457 nm): TAPPI/GE brightness for paper

T 525 om-92 Diffuse brightness of pulp (d/0°):ISO brightness for paper

T 646 om-94 Brightness of clay and other mineral pigments (45°/0°):

TAPPI/GE brightness for pigments

T534 wd-99 Brightness of clay and other mineral pigments (diffuse blue reflectance): ISO brightness for pigments

The calcium carbonate materials of the present invention have a mean particle size d₅₀, as measured by a Sedigraph™ 5100 machine (supplied by Micrometrics Corporation), of from about 5 microns (μm) to about 0.1 microns with respect to both GCC and PCC, preferably from about 2 micron to about 0.2 microns and where the product may be used in a paper coating composition, from about 0.8 microns to about 0.3 microns. The Sedigraph™ 5100 machine provides measurements, and a plot of the cumulative percentage by weight of particles having a size, referred to in the art as the “equivalent spherical diameter” (esd), less than the given esd values. The mean particle size, d₅₀, is the value determined in this way, of the particle esd at which there are 50% by weight of particles which have an esd less than that d₅₀ value.

Preferably, the calcium carbonate product produced by the method of the invention has a particle size distribution (psd) such that at least 50% by weight of the particles have a particle size <2 microns; more preferably, at least 60% by weight have a particle size <2 microns. The calcium carbonate product may be used as a pigment in a paper coating composition and in which case it may be especially preferred that at least 80% by weight of the calcium carbonate particles have a particle size <2 microns.

In a second aspect, the present invention provides a novel process for producing an improved alkaline earth metal carbonate product comprising the steps of:

1) slaking an alkaline earth metal oxide in water to form an aqueous slurry of alkaline earth metal hydroxide,

2) adding to the alkaline earth metal hydroxide slurry from about 0.01% to about 1.0% of a reductive bleaching agent, based on the weight of dry alkaline earth metal carbonate product, and

3) carbonating the alkaline earth metal hydroxide aqueous slurry at a temperature of at least about 50° C. with a carbon dioxide containing gas that is not substantially pure carbon dioxide to form a purified, reductively bleached alkaline earth metal carbonate aqueous slurry. In the present invention, the phrase “carbon dioxide containing gas that is not substantially pure carbon dioxide” means a gas containing no more than about 50% carbon dioxide by volume. The gas may contain from about 8% to about 30% carbon dioxide, it preferably will contain from about 10% to about 25% carbon dioxide.

The reductive bleaching agent may be FAS or hydros, preferably it is hydros. As in the first aspect, the alkaline earth metal carbonate may be ground prior to or subsequent to reductive bleaching. Preferably, the hydros is added to the alkaline earth metal hydroxide slurry prior to carbonation of the slurry. The hydros may be added to the slurry in solid form, or in the form of a solution, or in a suspension.

For both process aspects of the present invention, the alkaline earth metal carbonate slurry to which the reductive bleaching agent is added may have a solids content in the range of from about 10% by weight to about 80% by weight; preferably the solids content may be in the range of from about 15% by weight to about 78% by weight. The present invention is effective in both high solids slurries and low solids slurries. For high solids slurries, the solids content of the slurry to which the reductive bleaching agent is added should be in the range of from about 60% by weight to about 80% by weight. For low solids slurries, the solids content of the slurry to which the reductive bleaching agent is added should be in the range of from about 15% by weight to about 40% by weight. Preferably, for low solids reductively bleached slurries, the slurry is dewatered after said reductive bleaching step, which may be before and/or after grinding.

It is preferred that the bleaching agent, FAS or hydros, is added to the calcium carboriate suspension in conditions such that the pH level is relatively high, above about pH 7. The pH is preferably in the range of from about pH 7 to about pH 13, most preferably from about pH 8 to about pH 12.

The temperature of the slurry during the bleaching step should be relatively high, at least about 50° C. Preferably the temperature of the slurry during the bleaching step is from about 50° C. to about 100° C., most preferably from about 70° C. to about 75° C.

The time of the reductive bleaching step should be in the range of from about 5 minutes to about 60 minutes, preferably from about 5 minutes to about 10 minutes.

The amount of the reductive bleaching agent, FAS or hydros, to be added to the alkaline earth metal carbonate slurry or alkaline earth metal oxide should be from about 0.01% to about 1.0% (about 0.1 kg per tonne to 10 kg per tonne) by weight of the dry alkaline earth metal carbonate product, irrespective of the point in the process at which the reductive bleaching agent is added. The amount of reductive bleaching agent is preferably in the range of from about 0.020% to about 0.3% (about 0.20 kg per tonne to about 3 kg per tonne) by weight of the dry alkaline earth metal carbonate product.

Without wishing to be bound by theory, it is believed that the bleaching agent provided by the method of the invention may cause enhanced brightness of a calcium carbonate material, for example, by a redox reaction. Iron-containing impurities which may be present in a calcium carbonate, or, which may be displaced from the material of the grinding apparatus into a calcium carbonate suspension during grinding, may undesirably be present in the form of the +3 oxidation state (i.e. Fe³⁺). The beneficial effect of adding a bleaching agent comprising sodium dithionite or FAS to a calcium carbonate suspension may advantageously be caused by reducing the +3 oxidation state of the iron-containing impurities to the +2 oxidation state (i.e. Fe²⁺) and thereby bleaching the calcium carbonate particles.

Optionally, the process of the present invention may also include the addition of an effective amount of a phosphate additive which may function as a fixative to maintain the reduced iron-containing impurities in the Iron” state and thereby inhibit reversion to the Iron^{III} state. The amount of phosphate additive may be in the range of from about 0.1 kg per tonne to about 4 kg per tonne of calcium carbonate. Such a further step may preferably be applied to the bleached calcium carbonate suspension. A suitable phosphate additive may be a calcium hydrogen phosphate (CaHPO₄).

The method of the invention may comprise further step(s) of, for example, dewatering, washing and drying the alkaline earth metal carbonate slurry, which processes may be applied by known techniques. A suitable dewatering technique, for example, is disclosed in GB Application No. 9828514.1, which is incorporated herein by reference in its entirety.

Where the calcium carbonate to be bleached is a PCC, then the benefits provided by the method of the invention may advantageously permit the use of low-grade lime sources containing a significant amount of iron-containing impurities which lime sources are normally considered unusable.

The present invention also provides a composition of matter comprising an alkaline earth metal carbonate aqueous slurry combined with an amount of formamidine sulfinic acid sufficient to achieve reductive bleaching of the alkaline earth metal carbonate aqueous slurry.

The application suspension, or slurry, in which the calcium carbonate product is used may comprise, among other things, a paper making composition, e.g., a dilute aqueous suspension of cellulose fibers, the calcium carbonate being used as a filler material optionally with other materials. The composition in which the calcium carbonate product is used may also comprise a coating composition, e.g., for coating paper products. The production of a paper making or coating composition containing a calcium carbonate product produced in accordance with the method of the invention allows paper products of improved brightness to be obtained.

The calcium carbonate slurries of the present invention may also contain other conventional components. Convention components include, by are not limited to, biocides, suspension aides, dispersants, binders/adhesives, other pigments, lubricants, brightening agents, viscosity modifiers and water retention chemicals. For example, the composition may contain a dispersant. Such a dispersant may be a polyelectrolyte, preferably, a polyacrylate dispersant. More preferably, the dispersant is a sodium polyacrylate having a molecular weight <10,000.

The invention will now be described with reference to the following examples.

### EXAMPLE 1

An aqueous suspension of an Italian limestone was prepared having a solids content of 15% by weight of limestone. The limestone suspension was introduced into a grinding apparatus using sand as the grinding medium; the suspension was ground until the limestone particles had a particle size distribution such that 88% by weight of the particles had a particle size less than 2 μm. The ground suspension was heated to a temperature of 50° C. and 8 kg/T of sodium dithionite (hydros), based on the weight of the limestone, was added followed by addition of 4 kg/T of calcium hydrogen phosphate, based on the weight of the limestone. The reaction was carried out for 60 minutes; the limestone suspension was then filtered, washed and dried. The ISO brightness of the limestone was then measured at 91.3% brightness.

In a comparative experiment, by carrying out the experiment as just described but without the addition of a sodium dithionite bleaching agent, the measured ISO brightness of the limestone sample was found to be 88.1% brightness. The ISO brightness of the bleached limestone sample compared to the unbleached limestone sample has been raised by over 3.0%.

These results show that a calcium carbonate having an enhanced brightness can be obtained by the method of the invention.

Consequently, a paper making or paper coating composition incorporating such a calcium carbonate produced by the method of the invention may exhibit an enhanced brightness.

### EXAMPLE 2

A ground calcium carbonate product having 95 wt. % of the particles less than 2 μm and at 72 wt. % solids was treated with dry FAS bleach at 72° C. Dose and brightness data are shown in Table 1 below.

TABLE 1

| Bleach dose applied | |
|---|---|
| (wt. % active dry/dry) | Brightness (TAPPI) |
| 0.000 | 93.5 |
| 0.025 | 95.3 |
| 0.050 | 95.5 |
| 0.075 | 96.4 |
| 0.150 | 96.2 |
| 0.200 | 96.2 |

### EXAMPLE 3

A ground calcium carbonate product having 93 wt. % of the particles less than 2 μm and at 75 wt. % solids was treated with dry FAS bleach at 40° C. Dose and brightness data are shown in Table 2 below.

TABLE 2

| Bleach dose applied | |
|---|---|
| (wt. % active dry/dry) | Brightness (TAPPI) |
| 0.000 | 94.1 |
| 0.012 | 94.6 |
| 0.025 | 95.7 |
| 0.050 | 96.5 |
| 0.102 | 96.4 |
| 0.151 | 97.3 |
| 0.206 | 97.3 |

### EXAMPLE 4

A coarse GCC suspension was bleached with 0.10 wt. % FAS prior to grinding at 72 wt. % solids to a final particle size distribution of 96 wt. % less than 2 μm. The brightness increased from 92.0 to 93.1 (ISO).

### EXAMPLE 5

A ground calcium carbonate product having 85 wt. % of the particles less than 2 μm and at 25 wt. % solids was treated with FAS at a dose rate of 0.15 wt. %. The brightness increased from 91.9 (ISO) to 92.7 and further increased to 93.1 after centrifugal dewatering.

### EXAMPLE 6

A 0.15 wt. % FAS solution was applied to the final grinder of a cascade during the production of a 93 wt. % less than 2 μm GCC. The brightness increased from 91.9 to 93.4 (ISO).

### EXAMPLE 7

A rhombohedral PCC sample having a d₅₀ of 0.60 μm was bleached with 0.200 wt. % FAS after comminution and prior to dewatering. The product brightness increased from 96.5 to 98.2 (TAPPI).

### EXAMPLE 8

A ground aragonitic PCC sample having a d₅₀ of 0.35 μm was bleached with FAS prior to dewatering. Dose and brightness data are shown in Table 3 below.

TABLE 3

| Bleach dose applied (wt. % | |
|---|---|
| active dry/dry) | Brightness (ISO) |
| 0.000 | 94.4 |
| 0.10 | 95.7 |
| 0.15 | 95.8 |

### EXAMPLE 9

0.300 wt. % hydros was added to a lime suspension prior to carbonation. The resultant scalenohedral PCC had a brightness of 94.0 (ISO) relative to 92.5 for the control sample.

### EXAMPLE 10

The PCC pigments from Example 7 above were coated onto a wood-free base using a lab coater in a formulation comprising 44 parts no.1 coating kaolin, 35 parts PCC, 9 parts specialty pigment additives and 12 parts binder at a coat weight of 10 gsm. The sheet brightness for the control sheet was 81.8 while the sheet coated with FAS bleached PCC had a brightness of 82.2. (TAPPI)

### EXAMPLE 11

An unbleached GCC pigment having 96 wt. % less than 2 μm and an equivalent sample bleached with 0.075 wt. % FAS had pigment brightnesses of 93.6 and 95.5 respectively. These pigments were coated onto an uncoated wood-free base using a lab coater and a formulation comprising 89 parts GCC and 11 parts binder at 10 gsm. The sheet brightness for the control was 85.5 while the sheet coated with FAS bleached GCC had a brightness of 86.5 (ISO).

The process of the invention also takes into account the change in the various components comprising the aqueous slurry after combination with one another. Accordingly, the invention also relates to a product produced by the process of the invention.

The various numerical ranges describing the invention as set forth throughout the specification also include any combination of the lower ends of the ranges with higher ends of the ranges set forth herein, or any single experimental value or other single value set forth herein that will extend or reduce the scope of the lower or higher limits of the range, where the range includes, inter alia, ranges of concentrations of compounds, ratios of these compounds to one another, ranges of particle size, and particle size distribution, and the like, as well as all whole number, and/or fractional number values encompassed by these ranges, and ranges encompassed within these ranges. The term “about” as it applies to individual numerical values, or numerical values stated in the ranges of the present specification, means slight variations in these values. Any references to a United States patent and other printed publication set forth in the written description is incorporated in the written description by reference. All quantities of materials expressed in percentages are percentages by weight unless otherwise indicated.

Principles, various embodiments, and modes of operation of the present invention have been described in the foregoing written description. The invention which is intended to be protected here, however, is to be construed as including variations, and changes that may be made by those skilled in the art without departing from the spirit of the invention.

What is claimed is:

1. A process for providing an improved alkaline earth metal carbonate product comprising the steps of:
(a) preparing an aqueous slurry of an alkaline earth metal carbonate material, and (b) adding to said slurry an amount of formamidine sulfinic acid sufficient to achieve reductive bleaching of said alkaline earth metal carbonate material.

2. The process of claim 1 wherein said alkaline earth metal carbonate is chosen from at least one of a calcium carbonate material and a magnesium carbonate containing material.

3. The process of claim 1 wherein said alkaline earth metal carbonate is chosen from at least one of a naturally occurring calcium carbonate material and a precipitated calcium carbonate material.

4. The process of claim 3 further comprising the step of grinding said calcium carbonate material to obtain a ground calcium carbonate material.

5. The process of claim 4 wherein said formamidine sulfinic acid is added to said calcium carbonate aqueous slurry subsequent to said grinding step.

6. The process of claim 5 wherein the pH of said calcium carbonate aqueous slurry during said reductive bleaching step is in the range of from about 7 to about 13.

7. The process of claim 6 wherein the pH of said calcium carbonate aqueous slurry during said reductive bleaching is in the range of from about 8 to about 12.

8. The process of claim 7 wherein the temperature of said calcium carbonate aqueous slurry during said reductive bleaching is in the range of from about 50° C. to about 100° C.

9. The process of claim 8 wherein the temperature of said calcium carbonate aqueous slurry during said reductive bleaching is in the range of from about 70° C. to about 75° C.

10. The process of claim 8 wherein the time of said reductive bleaching is in the range of from about 5 minutes to about 60 minutes.

11. The process of claim 10 wherein the time of said reductive bleaching is in the range of from about 5 minutes to about 10 minutes.

12. The process of claim 10 wherein said calcium carbonate aqueous slurry has a solids content of from about 10% by weight to about 80% by weight.

13. The process of claim 12 wherein said calcium carbonate aqueous slurry has a solids content of from about 60% by weight to about 80% by weight.

14. The process of claim 12 wherein said calcium carbonate aqueous slurry has a solids content of from about 15% by weight to about 40% by weight.

15. The process of claim 14 further comprising the step of dewatering said calcium carbonate aqueous slurry subsequent to said reductive bleaching step.

16. The process of claim 3 wherein said calcium carbonate material is a precipitated calcium carbonate material.

17. The process of claim 16 wherein said precipitated calcium carbonate material is synthesized during step (a) by a process comprising the steps of
(1) slaking a calcium oxide material to produce slaked lime, and
(2) carbonating said slaked lime with a carbon-dioxide-containing gas to produce said precipitated calcium carbonate.

18. The process of claim 17 wherein said formamidine sulfinic acid is added during the synthesis of said precipitated calcium carbonate material in step (a).

19. The process of claim 18 wherein said formamidine sulfinic acid is added during the carbonation step of the synthesis of said precipitated calcium carbonate material in step (a).

20. The process of claim 19 further comprising the step, subsequent to step (a), of grinding said precipitated calcium carbonate aqueous slurry.

21. The process of claim 17 wherein said formamidine sulfinic acid is added in an amount of from about 0.01 % by weight to about 1.0% by weight of the dry calcium carbonate product.

22. The process of claim 21 wherein said formamidine sulfinic acid is added in an amount of from about 0.020% by weight to about 0.3% by weight of the dry calcium carbonate product.

23. A process for producing an improved alkaline earth metal carbonate product comprising the steps of:
(1) slaking an alkaline earth metal oxide in water to form an aqueous slurry of alkaline earth metal hydroxide,
(2) adding to said alkaline earth metal hydroxide slurry from about 0.01 % to about 1 % of a reductive bleaching agent, based on the weight of dry alkaline earth metal carbonate product, and
(3) carbonating said alkaline earth metal hydroxide aqueous slurry at a temperature of at least about 50° C. with a carbon dioxide containing gas that is not substantially pure carbon dioxide, to form a purified, reductively bleached alkaline earth metal carbonate aqueous slurry.

24. The process of claim 21 wherein said alkaline earth metal carbonate is chosen from at least one of a calcium carbonate material and a magnesium carbonate containing material.

25. The process of claim 22 wherein said alkaline earth metal carbonate is a calcium carbonate material.

26. The process of claim 23 wherein said carbon dioxide containing gas in step (c) contains from about 8% to about 30% carbon dioxide.

27. The process of claim 24 wherein said carbon dioxide containing gas in step (c) contains from about 10% to about 25% carbon dioxide.

28. The process of claim 24 wherein said reductive bleaching agent in step (b) is chosen from at least one of formamidine sulfinic acid and sodium dithionite.

29. The process of claim 26 wherein said reductive bleaching agent in step (b) is sodium dithionite.

30. The process of claim 27 wherein said calcium carbonate aqueous slurry has a solids content of from about 10% by weight to about 80% by weight of dry calcium carbonate product.

31. The process of claim 28 wherein said calcium carbonate aqueous slurry has a solids content of from about 60% by weight to about 80% by weight.

32. The process of claim 28 wherein said calcium carbonate aqueous slurry has a solids content of from about 15% by weight to about 40% by weight.

33. The process of claim 30 further comprising the step of dewatering said calcium carbonate aqueous slurry subsequent to said reductive bleaching step.

34. The process of claim 21 wherein the step (b) addition of a reductive bleaching agent takes place during the step (c) slurry carbonation.

35. A composition of matter comprising an alkaline earth metal carbonate aqueous slurry combined with an amount of formamidine sulfinic acid sufficient to achieve reductive bleaching of said alkaline earth metal carbonate aqueous slurry.

36. A product produced by the process of claim 1.

37. A product produced by the process of claim 19.

38. A product produced by the process of claim 21.
